(19) United States
(12) Patent Application Publication
(10) Pub. No.: US 2008/0045202 A1
(43) Pub. Date: Feb. 21, 2008

(54) REMOTE CONTROL METHOD THROUGH WIRELESS TRANSMISSION

(75) Inventors: Chun-Kai Chan, Taipei (TW); Li-Hsiang Liao, Taipei (TW); Ya-Shu Juang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/768,918

(22) Filed: Jun. 27, 2007

(30) Foreign Application Priority Data
Aug. 21, 2006 (TW) 95130611

(51) Int. Cl. H04M 3/00

(52) U.S. Cl. 455/420

(57) ABSTRACT

A remote control method through wireless transmission is provided. The method includes the following steps: (A) a portable computer determines whether a wireless signal outputted from a mobile apparatus having a wireless transmission module is received; (B) if the portable computer receives the wireless signal, the portable computer searches whether a wireless control command corresponding to the wireless signal is in a multimedia command table; (C) the portable computer executes a multimedia command corresponding to the wireless control command to control audio/video playing in the portable computer when the wireless control command is found in the multimedia command table.

### CROSS-REFERENCE TO RELATED APPLICATION

This application claims the priority benefit of Taiwan application serial no. 95130611, filed Aug. 21, 2006. All disclosure of the Taiwan application is incorporated herein by reference.

### BACKGROUND OF THE INVENTION

1. Field of the Invention

The present invention relates to a remote control method. More particularly, the present invention relates to a remote control method through wireless transmission.

2. Description of Related Art

Along with the development of computer technology, personal computers, cell phones, personal digital assistants (PDA) etc have become indispensable in our daily life. In the information age, since computers can be broadly applied to multimedia, network, data storage, information transmission etc, they have become the essential tool in most of industries, and almost every family owns at least one personal computer.

Due to the popularity and advancement of computer technology, multimedia application in computer has become the killer application on the market. Various manufacturers have introduced many conceptual products with personal computers or example, TV software such as Mediacenter or Powercinema, when a remote control is to be used, an infrared receiver has to be installed in the computer, and a matching remote control has to be used.

However, in today's fast-paced life, a user may not be able to find the remote control, which may cause inconvenience to the user. Besides, sometimes the infrared receiver cannot receive signals from the remote control due to incorrect installation.

### SUMMARY OF THE INVENTION

Accordingly, the present invention is directed to provide a remote control method through wireless transmission, wherein the method allows a user to use a multimedia program remotely.

According to another aspect of the present invention, a remote control method through wireless transmission is provided. The method allows a user to remotely control a controllable apparatus without aiming at the controllable apparatus.

According to yet another aspect of the present invention, a remote control method through wireless transmission is provided. The method allows a user to skip the cost for purchasing another remote control and a receiver, and the user does not have to carry a remote control or a receiver when the user goes out.

The present invention provides a remote control method through wireless transmission. The method includes the following steps: (A) a portable computer determines whether a wireless signal outputted by a mobile apparatus is received; (B) If the portable computer receives the wireless signal, the portable computer searches whether a wireless control command corresponding to the wireless signal is in a multimedia command table; (C) when the wireless control command is found in the multimedia command table, the portable computer executes a multimedia command corresponding to the wireless control command to control video/audio playing in the portable computer.

According to the remote control method through wireless transmission in an exemplary embodiment of the present invention, before step (A) is executed, the portable computer and the mobile apparatus establish a connection through a wireless transmission protocol so that the mobile apparatus becomes a human interface device.

According to the remote control method through wireless transmission in an exemplary embodiment of the present invention, in step (A), the portable computer continues to execute step (A) if the portable computer does not receive a wireless control command. In an embodiment, in step (B), the portable computer continues to execute step (A) if the wireless control command is not found in the multimedia command table. In the present embodiment, the portable computer may be a notebook computer, a tablet PC, a palmtop computer, or an ultra mobile PC (UMPC). The mobile apparatus may be a cell phone, a smart phone, or a personal digital assistant (PDA).

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating the remote control method through wireless transmission according to an embodiment of the present invention.

FIG. 2 illustrates the computer apparatus used in FIG. 1.

FIG. 3 is a diagram of a cell phone 21 according to an embodiment of the present invention.

FIG. 4 is a diagram of a multimedia command table according to an embodiment of the present invention.

### DESCRIPTION OF EMBODIMENTS

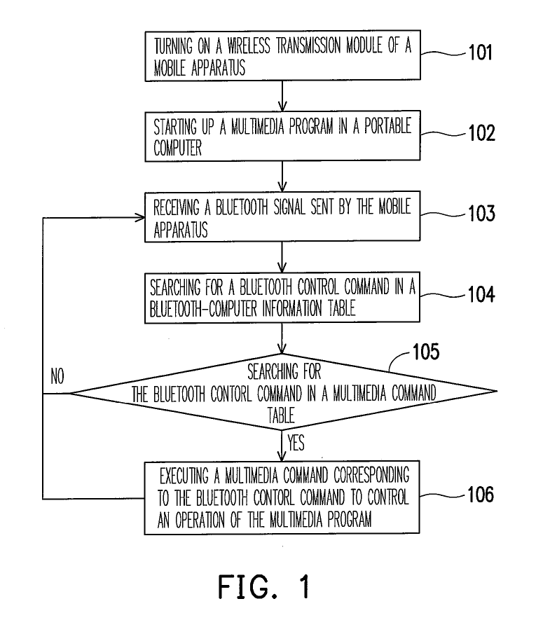

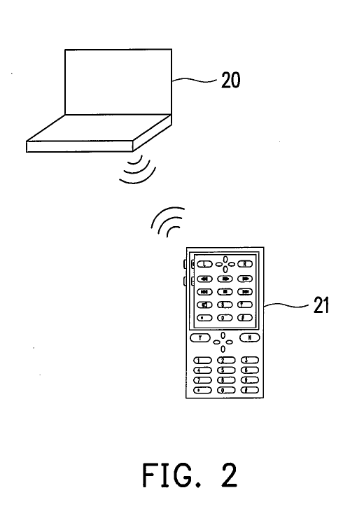

FIG. 1 is a flowchart illustrating the remote control method through wireless transmission according to an embodiment of the present invention. FIG. 2 illustrates the computer apparatus used in FIG. 1. Bluetooth technique is adopted in the present embodiment as the wireless transmission protocol, while in other embodiments, the wireless transmission protocol may also be 802.11 b/g or other protocols. Besides, the apparatuses used in the present embodiment include a portable computer 20 having a Bluetooth communication module and a cell phone 21. In the present embodiment, the portable computer 20 is a notebook computer, while in other embodiments, the portable computer 20 may be a tablet PC, a palmtop, or an ultra mobile PC (UMPC).

An exemplary embodiment of the present invention will be described with reference to FIG. 1 and FIG. 2. In the following description, the scenario is that a user uses a notebook computer to watch TV and a cell phone as the remote control. In step 101, the user starts up the wireless transmission module of the mobile apparatus with wireless transmission protocol. In the present embodiment, the mobile apparatus is a cell phone 21 having a Bluetooth module, while in other embodiments, the mobile apparatus may also be a smart phone or a personal digital assistant (PDA).

In step 102, the user executes a multimedia program in the notebook computer, for example, a TV playing program, to display video images on the screen of the notebook computer and to turn on the Bluetooth module of the notebook computer, so that the notebook computer and the cell phone 21 establish a connection and accordingly the cell phone 21 becomes a human interface device (HID). Please note that, in the present embodiment, the execution sequence of steps 101 and 102 can be switched without affecting the subsequent operations. Next, the user remotely controls the video images in the notebook computer through the cell phone 21.

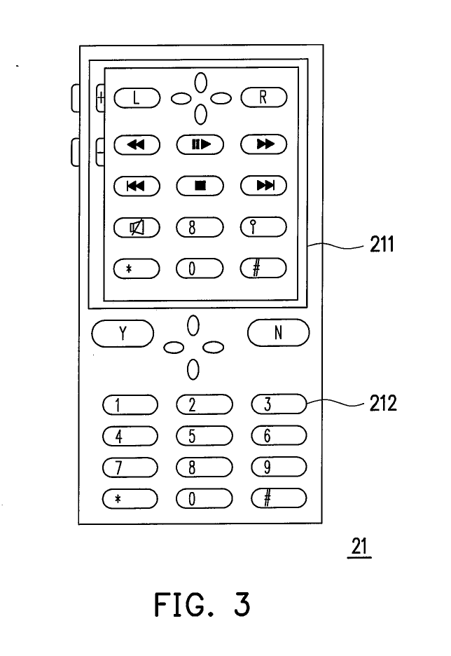

It should be mentioned here that, in step 101, when the Bluetooth module of the cell phone 21 is turned on, and at the same time the remote control function of the cell phone 21 is also turned on so that the screen 211 of the cell phone 21 presents what is illustrated in FIG. 3. In FIG. 3, a button set 212 is disposed on the cell phone 21 and a plurality of remote control buttons are displayed on screen 211. The remote control buttons include the button set 212 and other buttons such as volume control buttons.

For example, button 1 corresponds to rewind function, button 2 corresponds to pause function, button 3 corresponds to fast forward function, button 4 corresponds to previous channel (or previous music) function, button 6 corresponds to next channel (or next music) function, button 5 corresponds to stop function, and button 7 corresponds to mute function. The two buttons at the left side of the cell phone 21 can be used for adjusting the sound volume of the notebook computer. In addition, in the present embodiment, the arrow buttons, accept buttons, dial buttons can be used as operation buttons approximately to a mouse.

Accordingly, the user can control the operation of the notebook computer to play video images by pressing down the foregoing buttons.

In step 103, after starting up the multimedia program, the portable computer 20 determines whether the portable computer 20 receives a Bluetooth signal output by the cell phone 21 through the wireless transmission module thereof. The portable computer 20 continues to determine whether the portable computer 20 receives a Bluetooth signal from the cell phone 21 if the portable computer 20 does not receive a Bluetooth signal from the cell phone 21. The portable computer 20 proceeds to the next step if the portable computer 20 receives a Bluetooth signal sent by the cell phone 21.

For example, when the user presses down button 4 of the cell phone 21 to control the multimedia program in the portable computer 20 to switch to a previous channel (i.e. to perform a channel up action, which is denoted by symbol “↑”), the cell phone 21 produces a Bluetooth signal corresponding to button 4 and sends the Bluetooth signal to the portable computer 20. The portable computer 20 receives the “channel up” Bluetooth signal “0x00A0” through the wireless transmission module thereof. Next, the portable computer 20 searches for a Bluetooth control command “↑” corresponding to “0X00A0” in a Bluetooth-computer information table (step 104).

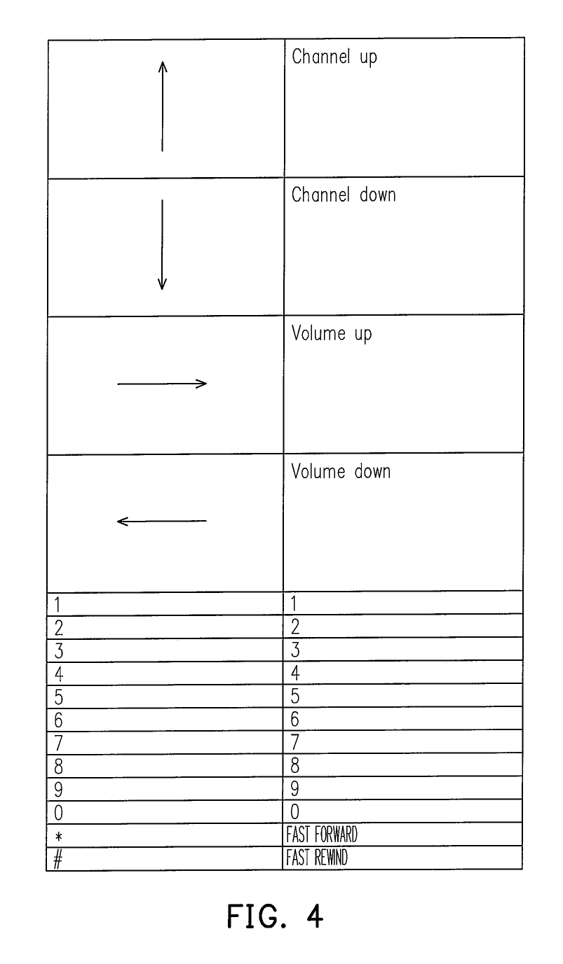

In step 105, the portable computer 20 searches for the Bluetooth control command “↑” in a multimedia command table as shown in FIG. 4. If the Bluetooth control command “↑” is not found in the multimedia command table, the portable computer 20 continues to execute step 103, otherwise, the portable computer 20 proceeds to the next step 106.

In step 106, if the Bluetooth control command “↑” is found in the multimedia command table, the multimedia program in the portable computer 20 (namely, the TV playing program) executes the “channel up” command corresponding to the “↑” command, so that video images of another channel are displayed on the screen of the portable computer 20.

Similarly, the user can also control the operations of the multimedia program, for example, channel switching, volume adjustment, fast forward, or slow motion etc, in the portable computer 20 through the buttons on the cell phone 21.

Please note that, in the present embodiment, even though a Bluetooth transmission module is used as the wireless transmission module, while in other embodiments, the Bluetooth transmission module may also be replaced by other wireless transmission modules of different specifications. Besides, the Bluetooth signal may also be replaced by other wireless signals, and the Bluetooth control command may also be replaced by other wireless control commands. In addition, the definitions of the buttons of the cell phone in FIG. 2 and FIG. 3 are as described above; however, in other embodiments, the definitions of the buttons may be changed according to other particular requirements or functions. The definitions in the multimedia command table may also be changed correspondingly.

As described above, the most popular Bluetooth communication protocol is adopted in the present embodiment for controlling the multimedia program. The user can remotely control the multimedia system in a computer by using only a Bluetooth cell phone or a hand-held mobile apparatus which supports Bluetooth system, such as a PDA. Even though Bluetooth wireless transmission is used in the embodiment described here, it should be understood by those having ordinary skill in the art that other wireless transmission standard such as 802.11a b g or Wi-Fi may also be used to achieve the same functions.

In overview, according to the present invention, wireless transmission technique is adopted in a computer system for accomplishing remote control function, thus, unlike a conventional infrared remote control, the remote control in the present invention can be used for remotely controlling a multimedia program in the computer without worrying about the direction of the remote control. In addition, if Bluetooth technique is used as the wireless transmission protocol in the present invention, due to the wide application of Bluetooth, the user can just use a Bluetooth cell phone/PDA as a remote control and the manufacturer can also skip the cost of the remote control.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A remote control method through wireless transmission, the method comprising:
(A) a portable computer determining whether a wireless signal outputted by a mobile apparatus is received;
(B) if the portable computer receives the wireless signal, the portable computer searches whether a wireless control command corresponding to the wireless signal is in a multimedia command table; and
(C) if the wireless control command is found in the multimedia command table, the portable computer executes a multimedia command corresponding to the wireless control command to control video/audio playing in the portable computer.

2. The remote control method as claimed in claim 1, wherein before step (A) is executed, the portable computer and the mobile apparatus establish a connection through a wireless transmission protocol so that the mobile apparatus becomes a human interface device (HID).

3. The remote control method as claimed in claim 1, wherein in step (A), the portable computer continues to execute step (A) if the portable computer does not receive the wireless control command.

4. The remote control method as claimed in claim 1, wherein in step (B), the portable computer continues to execute step (A) if the wireless control command is not found in the multimedia command table.

5. The remote control method as claimed in claim 1, wherein the portable computer is a notebook computer, a tablet PC, a palmtop computer, or a ultra mobile PC (UMPC).

6. The remote control method as claimed in claim 1, wherein the mobile apparatus is a cell phone, a smart phone, or a personal digital assistant (PDA).
